(19) United States
(12) Patent Application Publication
(10) Pub. No.: US 2008/0074832 A1
(43) Pub. Date: Mar. 27, 2008

(54) Rereconfigurable structure for panel of portable personal computer

(75) Inventors: Leo Ming Tz Chien, Taipei City (TW); Chia-Shyong Cheng, Taipei City (TW); Yu-Min Fang, Taipei City (TW); Yi-Chan Tseng, Taipei City (TW)

Correspondence Address: BRUCE H. TROXELL, SUITE 1404, 5205 LEESBURG PIKE, FALLS CHURCH, VA, 22041, US

(73) Assignee: First International Computer, Inc.

(21) Appl. No.: 11/798,045

(22) Filed: May 9, 2007

(30) Foreign Application Priority Data
May 19, 2006 (TW) 095117888

(51) Int. Cl. G06F 1/16

(52) U.S. Cl. 361/683

(57) ABSTRACT

A reconfigurable structure for a panel of a portable personal computer is adapted to allow the panel of a portable computer housing to be coupled a coupling item at two side thereof respectively; two ends of a band are respectively coupled with one of the two sides of the panel; allows the band to be fastened above the panel of the portable computer, and an article to be held between the band and the panel of the portable computer. Whereby, the outlook or the pattern of the panel of the computer can be changed to attain to the requirement that the outlook of the computer is matched up with a personalized desire.

### BACKGROUND OF THE INVENTION

1. Field of the Invention

The present invention relates to a panel of a housing of a portable personal computer, and more particularly to a reconfigurable structure for a panel of a portable personal computer.

2. Brief description of related art

The functions of a portable computer are stronger recently and the portable convenience of the computer itself can feed consumers' purchasing appetite. A panel at the back of a display screen of a general portable computer is not always reconfigurable; a pattern thereon cannot be changed depending on a user's need or further coupled to other articles.

U.S. Pat. No. 6,125,033 discloses a reconfigurable panel for a mobile computer, it comprises an attachment plate having a first surface and a second surface, in which the first surface is adapted to couple to an outer surface of an enclosure portion of a chassis of the mobile computer opposing a display thereof and a panel housing that is coupled to the second surface of the attachment plate, the different panel housing can be changed depending on a user's need. The panel housing can have cosmetic and/or functional attributes. The panel housing can be made of a durable substance like transparent or color plastic or textile or stainless steel, or coupled to other electronic elements to constitute a solar source.

The patent mentioned above discloses sticking an attachment plate to panel housing, and then allowing the attachment plate to be coupled to an outer surface of an enclosure portion of a chassis of the mobile computer so as to meet a user's requirement to change the panel housing. But, the panel housing needs to be stuck to the attachment plate first and it can then be coupled to the computer chassis, the coupling structure thereof is rather complex and the production cost is rather consuming. Although it mentions that a slit exists between the attachment plate and the panel housing for allowing thin articles like photographs or documents to be placed in, the thin articles placed between the panel housing and the attachment plate are not easy to be changed after the housing panel is stuck to the attachment plate. Besides, a user easily sees portions of the attachment plate without the placed-in thin article through the transparent panel housing; this causes visual portions of the whole panel housing to be not artistic.

### SUMMARY OF THE INVENTION

For simplifying a reconfigurable structure for a panel of a portable personal computer and being convenient for changing thin articles placed on the panel, the present invention is proposed.

The main object of the present invention is to provide a reconfigurable structure for a panel of a portable computer, having a simple structure and capable of saving the production cost.

Another object of the present invention is to provide a reconfigurable structure for a panel of a portable computer, being convenient for the panel of the computer to be changed with different modeling and pattern.

Still another object of the present invention is to provide a reconfigurable structure for a panel of a portable computer, being convenient for allowing a thin article to be placed on the panel and a different thin article to be changed.

Still another object of the present invention is to provide a reconfigurable structure for a panel of a portable computer, capable of providing a same type of computer with various profiles to a buyer, increasing the production and the sale amounts of a same basic type of product without needing manufacturing different profiles and modeling of products and saving the product cost greatly to increase the profit of a computer manufacturer.

For attaining to the objects mentioned above, a reconfigurable structure for a panel of a portable personal computer is adapted to couple to the panel of a portable personal computer housing, comprises:

a portable personal computer, two sides of a panel of the portable personal computer housing respectively couple a coupling item;

a band, which is provided with a first coupling section and a second coupling section close to a first end and a second end thereof respectively;

wherein the first coupling section and the second coupling section respectively couple one of the two coupling items; whereby, the two ends of the band couple one of the coupling items and are fastened on the top planar surface of the panel of the portable personal computer; allows an article to be held between the band and the panel of the portable computer. An outlook or pattern of the panel of the computer can be changed to attain to the personal requirement to the computer outlook. And, the computer with a same type and various outlooks is allowed to supply to different purchasers; this can save the production cost greatly and increase the profit of the computer manufacturer.

### BRIEF DESCRIPTION OF THE DRAWINGS

The present invention can be more fully understood by reference to the following description and accompanying drawings, in which:

FIG. 1 is a schematic view, showing a reconfigurable structure for a panel of a portable computer of a first preferred embodiment according to the present invention;

FIG. 2A is a schematic view, showing a use state of a reconfigurable structure for a panel of a portable computer of a first preferred embodiment according to the present invention;

FIG. 2B is a schematic view, showing another use state of a reconfigurable structure for a panel of a portable computer of a first preferred embodiment according to the present invention;

FIG. 3 is a schematic view, showing a reconfigurable structure for a panel of a portable computer of a second preferred embodiment according to the present invention;

FIG. 4 is a schematic view, showing a reconfigurable structure for a panel of a portable computer of a third preferred embodiment according to the present invention;

FIG. 5 is a schematic view, showing reconfigurable structure for a panel of a portable computer of a fourth preferred embodiment according to the present invention; and

FIG. 6 is a schematic view, showing a reconfigurable structure for a panel of a portable computer of a fifth preferred embodiment according to the present invention.

### DETAILED DESCRIPTION OF THE PREFERRED EMBODIMENTS

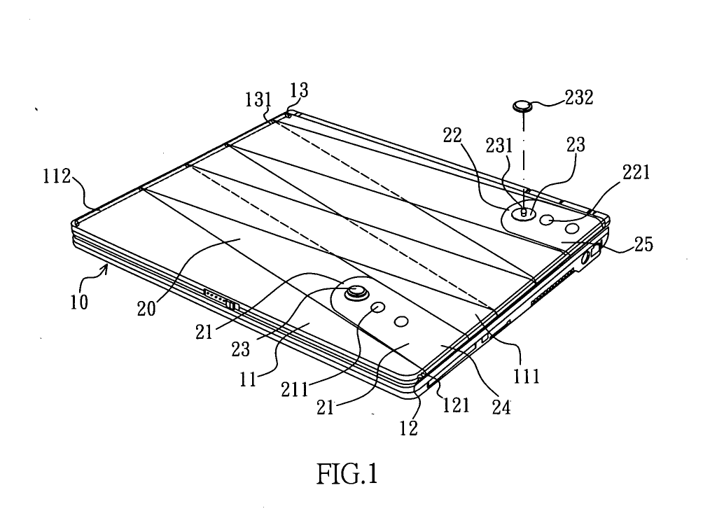

Please refer to FIG. 1. A reconfigurable structure for a panel of a portable computer of a first preferred embodiment according to the present invention is adapted to couple to the panel of a portable computer housing and comprises a portable computer 10, a panel 11 at the back of a display screen of the housing thereof in which the panel 11 is coupled with a first and a second coupling items 12, 13 such as rods at a first and a second sides 111, 112 of the panel 11 respectively; there are a first and a second slits 121, 131 between the coupling items 12, 13 and the sides 111, 112 of the panel 11 respectively; a band 20, which is provided with a plurality of holes 211, 221 which put in order close to a first end 21 and a second end 22 thereof respectively. The first end 21 of the band 20 passes through the first slit 121, then put around the first coupling item 12 to lean on the band 20, and then causes an axis 231 of a buckle 23 to pass through two overlap holes 211; then causes a hat section 232 of the buckle 23 to buckle the axis section 231; thus, the first end 21 of the band 20 forms a first coupling section 24, and the first coupling section 24 is put around the first coupling item 12. According to this embodiment, the second end 22 of the band 20 passes through the second slit 131 which closes to the second side 112 of the panel 11, and put around the second coupling item 13, then passes through the first slit 121 of the first side 111 of the panel 11, then passes through the first coupling item 12, then passes through the second slit 131 of the second side 112 of the panel 11, then put around the second coupling item 13, then passes through the first slit 121 of the first side 111 of the panel 11, and then put around the first coupling item 12. It leans on the band 20, then causing an axis section 231 of another buckle 23 to pass through two overlapping holes 221, then applying another cap section 232 to slip over the axis section 231. It causes the second end 23 to fasten the band 20 and to form a second coupling section 25, the second coupling section 25 of the band 20 is put around the first coupling item 12, and these two ends of the band 20 are coupled to the first coupling item 12 and fastened on the top of the panel 11.

The band 20 of the present embodiment can be a flexible and transparent band, be provided with different length and width, or allow a brand name, trademark or decorative patterns to be disposed on the band 20; after the band 20 is fastened on the top of the panel 11, to allow an outlook of a housing of the portable computer 10 to be formed with a different modeling or pattern.

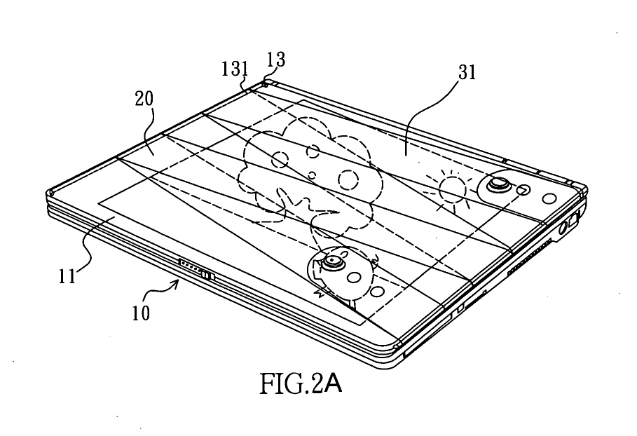

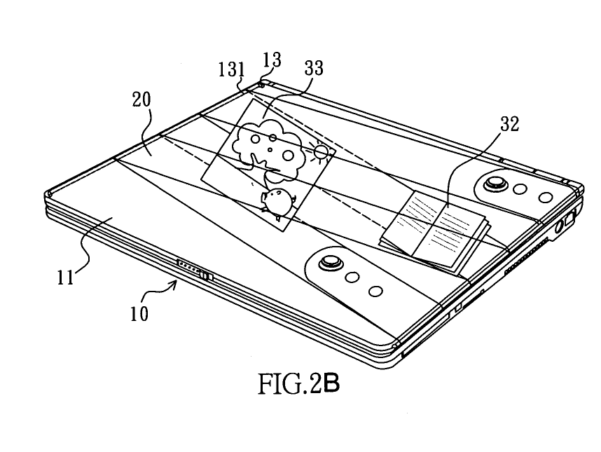

Please refer to 2A, 2B. According to the present embodiment, a decorative sheet 31 such as a picture or a patterned paper etc. can be clamped into between the band 20 and the panel 11. The decorative sheet 31 can be whole or partial overlaid on the panel 11 as FIG. 2A shows. It causes an outlook of a housing of the portable computer 10 to be formed with a different modeling or pattern, and it then achieves the demand for personalized variations. According to the present embodiment, it also can take the thin articles such as a documents 32, a pictures 33 or other small articles etc. to be clamped into between the band 20 and panel 11 and the documents 32, pictures 33 can be taken out anytime conveniently then replacing them with different thin articles, or it is convenient for carrying the small articles as FIG. 2B shows.

According to the present embodiment, it is convenient for the band 20 to couple on the top of the panel 11, by means of different design of shape, modeling or patterns for the band 20, or clamps with different decorative sheets, and then the portable computer 10 has a different outward appearance of individual style.

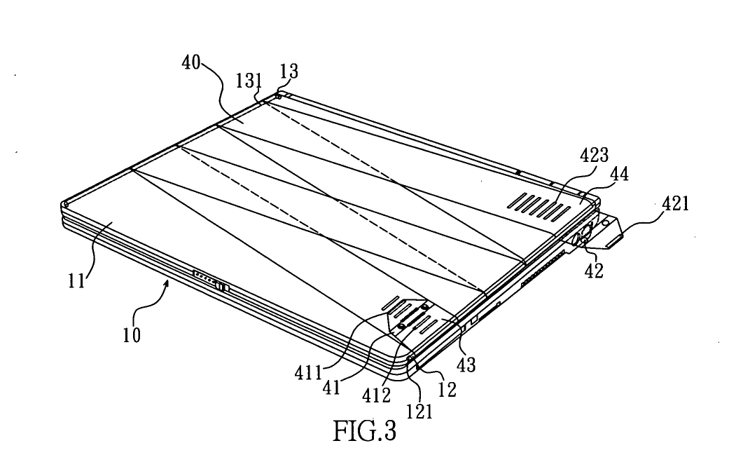

Please refer to FIG. 3. A reconfigurable structure for a panel of a portable computer of a second preferred embodiment according to the present invention is provided with almost the same structure as the first embodiment, but a first end 41 and a second end 42 of the band 40 are respectively coupled by a hook 411, 421, and the two ends of the band 40 is provided with buckling holes 412, 422 which put in order and correspond to the hook 411, 421 respectively. Allows these hooks 411, 421 to pass through the first slit 121 respectively, then to put around the first coupling item 12 to attach to the buckling holes 412, 422 respectively, and then form a first and a second coupling section 43, 44 cause the band 40 to be fastened on the top planar surface of the panel 11 of the portable computer 10. The first and second slit 121, 131 between the coupling items 12, 13 and two sides 111, 112 of the panel 11 of the portable computer 10 respectively are larger enough for the hooks 411, 421 to pass through. This embodiment can achieve the same effects as the first embodiment.

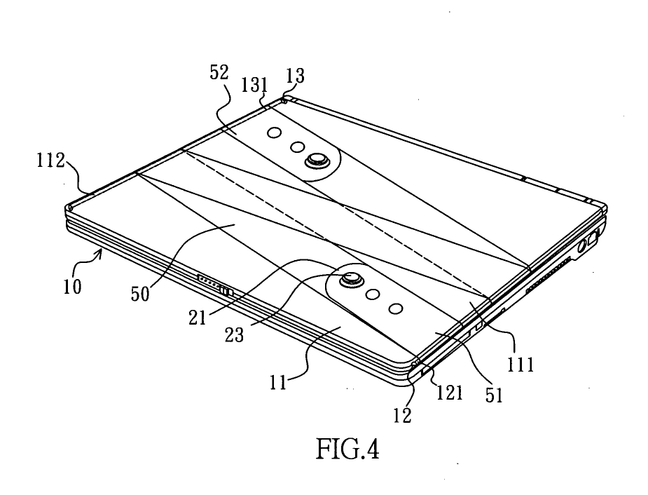

Please refer to FIG. 4. A reconfigurable structure for a panel of a portable computer of a third preferred embodiment according to the present invention is provided with almost the same structure as the first embodiment, but a band 50 is shorter. A first coupling section 51 of the band 50 couple the coupling item 12 of the first side 111 of the panel 11 of the portable computer 10, and a second coupling section 52 of the band 50 couples the coupling section 13 of the second side 112 of the panel 11. This embodiment also can achieve the same effects as the first embodiment.

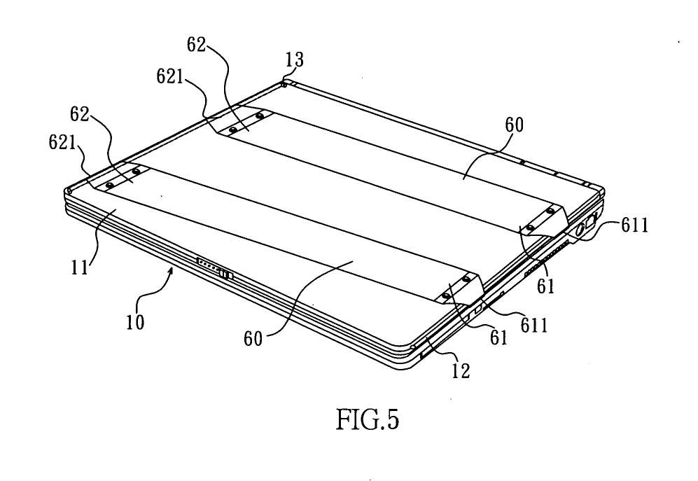

Please refer to FIG. 5. A reconfigurable structure for a panel of a portable computer of a fourth preferred embodiment according to the present invention is provided with almost the same structure as the second embodiment, a first and a second end 61, 62 of a band 60 are respectively coupled a hook 611, 621, but the band 60 is shorter and can match with the length of the panel 11, and two ends of the band 60 is not provided with buckling holes which can correspond to a hook 611, 621 respectively. These hooks 611, 621 respectively act as a first and a second coupling section, and it directly attaches to the coupling items 12, 13 of two sides of panel 11 of the portable computer 10. Thus, the band 60 can be fastened on the top of the panel 11. In this embodiment, the plurality of bands 60 can be fastened on the top planar surface of the panel 11; it also can achieve the same effects as the first embodiment.

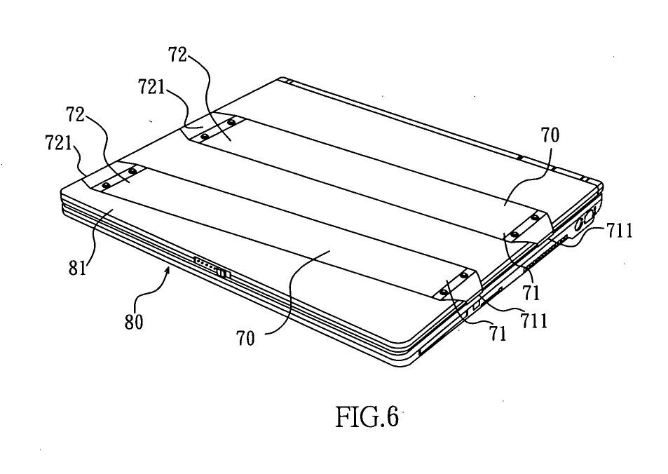

Please refer to FIG. 6. A reconfigurable structure for a panel of a portable computer of a fifth preferred embodiment according to the present invention is provided with almost the same structure as the fourth embodiment, a first end and a second end 71, 72 of a band 70 are respectively coupled a hook 711, 721, and the length of the band 70 matches with the length of the panel 81 of the portable computer 80. These hooks 711, 722 are respectively acted as a first and a second coupling section; they directly attach to two sides of the panel 81 of the portable computer 80. Thus, the band 70 can be fastened on the top planar surface of the panel 81. In this embodiment, two sides of the panel 81 are acted as a coupling item respectively, which couple the band 70. This embodiment causes pluralities of bands 70 fastened on the top planar surface of the panel 81, and it also can achieve the same effects as the first embodiment. The present invention can also use other combining method, such as using an adhesive method or a fixed method that using a screw or a rivet. Thus, causing the first end and the second end respectively couple the two sides of the panel of a portable computer.

A reconfigurable structure for a panel of a portable computer disclosed in the present invention allows an outlook or pattern of the panel of the computer to be changed to attain to the requirement the outlook of the computer is matched up with the personalized desire so as to stimulate consumers' desire to purchase. Besides, a computer manufacturer can provide different purchaser with a same type of computer with different outlooks by means of the reconfigurable structures for a panel of a portable computer disclosed in the present invention. this is also to say that only changing a cover plate or a place-in pattern can change the outlook to attain to the growth of the production and the sale amounts of a same fundamental type of product without needing to respectively manufacture different outlook and modeling of products so as to be able to save the production cost greatly and increase the profit of the computer manufacturer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reconfigurable structure for a panel of a portable personal computer is adapted to couple to the panel of a portable computer housing, comprises:
said panel of said portable personal computer housing having two sides, said two sides of said panel respectively couple a coupling item;
a band, provided with a first coupling section and a second coupling section close to a first end and a second end thereof respectively;
wherein the first coupling section and the second coupling section respectively couple one of the two coupling items; whereby, the two ends of the band couple one of the coupling items are fastened on the top planar surface of the panel of the mobile computer; allows an object to be held between the band and the panel of the portable personal computer.

2. The reconfigurable structure for a panel of a portable personal computer according to claim 1, wherein the first coupling section of the band couples the coupling item of a first side of the panel; the second coupling section of the band couples the coupling item of a second side of the panel.

3. The reconfigurable structure for a panel of a portable personal computer according to claim 1, wherein there is a slit between the coupling item and the side of the panel; the first coupling section of the band couples the coupling item of a first side of the panel; the second end of the band at least passes through the slit on a second side of the panel, and at least one time put around the coupling item of the second side of the panel; the second coupling item of the band couples the coupling item of the first side of the panel.

4. The reconfigurable structure for a panel of a portable personal computer according to claim 1, wherein there is a slit between the coupling item and the side of the panel; the first coupling section of the band couples the coupling item of a first side of the panel; the second end of the band at least passes through the slit on a second side of the panel, and at least one time put around the coupling item of the second side of the panel, at least one time passes through the slit on the first side of the panel, and at least one time put around the coupling item of the first side of the panel; the second coupling item of the band couples the coupling item of the second side of the panel.

5. The reconfigurable structure for a panel of a portable personal computer according to claim 1, wherein the band is provided with at least two holes which closes to a first end; the first end of the band folds inversely and leans on the band; an axis of a buckle passes through the two overlapping holes, and then fastens to a hat section of the buckle causes the first end of the band to form the first coupling section.

6. The reconfigurable structure for a panel of a portable personal computer according to claim 5, wherein the band is provided with at least two holes which closes to a second end; the second end of the band folds inversely and leans on the band; an axis of another buckle passes through the two overlapping holes, and then fastens to a hat section of the another buckle causes the second end of the band to form the second coupling section.

7. The reconfigurable structure for a panel of a portable personal computer according to claim 1, wherein the band is provided with at least two buckling holes which closes to a first end; a first end of the band fastens a hook; the first end of the band is folded inversely and leans on the band; the hook fastens the buckling hole causes the first end of the band to form the first coupling section.

8. The reconfigurable structure for a panel of a portable personal computer according to claim 7, wherein the band is provided with at least two buckling holes which closes to a second end; the first end of the band fastens another hook; the second end of the band is folded inversely and leans on the band; the another hook fastens the buckling hole causes the second end of the band to form the second coupling section.

9. The reconfigurable structure for a panel of a portable personal computer according to claim 2, wherein there is a slit between the two coupling items and the two sides of the panel respectively; a first end and a second end of the band respectively couple a hook; the length of the band matches with the length of the panel; the two hooks are respectively acted as the first coupling section and the second coupling section; the two hooks are respectively fastened to the coupling item of the two sides of the panel.

10. The reconfigurable structure for a panel of a portable personal computer according to claim 9, wherein the panel respectively couples at least two bands.

11. The reconfigurable structure for a panel of a portable personal computer according to claim 1, wherein the band is provided with one of a brand name, logo and a decorative design.

12. The reconfigurable structure for a panel of a portable personal computer according to claim 1, wherein the band is flexible and transparent band; whereby allows a thin articles which selects from any one of a decorative sheet, document and photo can be held between the band and the panel of the portable computer housing.

13. A reconfigurable structure for a panel of a portable personal computer is adapted to couple to the panel of a portable computer housing, comprises:
said panel of said portable personal computer housing having two sides;
a band, which is provided with a first end and a second end thereof respectively; the first end and the second end of the band are respectively coupled with the two sides of the panel.

14. The reconfigurable structure for a panel of a portable personal computer according to claim 13, wherein the band couples a hook which close to the first end and the second end respectively, the hooks are respectively fastened to the two sides of the panel.

15. The reconfigurable structure for a panel of a portable personal computer according to claim 13, wherein the band is provided with any one of a brand name, logo and a decorative design.

16. The reconfigurable structure for a panel of a portable personal computer according to claim 14, wherein the band is provided with any one of a brand name, logo and a decorative design.

17. The reconfigurable structure for a panel of a portable personal computer according to claim 13, wherein the band is flexible and transparent band; whereby allows a thin articles which selects from any one of a decorative sheet, document and photo can be held between the band and the panel of the portable computer housing.

18. The reconfigurable structure for a panel of a portable personal computer according to claim 14, wherein the band is flexible and transparent band; whereby allows a thin articles which selects from any one of a decorative sheet, document and photo can be held between the band and the panel of the portable computer housing.
